(19) United States
(12) Patent Application Publication
(10) Pub. No.: US 2004/0107250 A1
(43) Pub. Date: Jun. 3, 2004

(54) METHODS AND SYSTEMS FOR INTEGRATING COMMUNICATION RESOURCES USING THE INTERNET

(76) Inventor: Guillermo Marciano, Berkeley, CA (US)

Correspondence Address: MARCIANO, Guillermo, P.O.Box 12368, Berkeley, CA, 94712-3368

(21) Appl. No.: 10/605,700

(22) Filed: Oct. 21, 2003

Related U.S. Application Data
(60) Provisional application No. 60/421,847, filed on Oct. 21, 2002.

(51) Int. Cl. G06F 15/173; G06F 15/16

(52) U.S. Cl. 709/204; 709/223

(57) ABSTRACT

The present invention relates to computer methods and systems for integrating technologies widely available that can be used for synchronous and non-synchronous communications. It particularly enables bidirectional communication through web sites using software already installed in Users' computers. The system provides an infrastructure for diverse solutions.

### BACKGROUND OF INVENTION

1. Technical Field

The present invention relates in general to methods and systems for integrating and coordinating different communication resources using the Internet.

Mentioned methods and systems allow the usage of just four basic elements in the User Interface (Content, Session, User and Group), simplifying the management of the whole system so that any individual with no technical knowledge could set up and configure the system itself and the resources integrated to it.

The Invention provides a frame to handle diverse communications in a very flexible way, for example: allows the rejection and filtering of undesirable or not relevant communications like SPAM or telemarketing; and allows to have bidirectional communications through a web site and to use a web site for the reception of people who then can communicate with other people or automated systems in synchronous and non-synchronous ways.

2. Background of the Invention

People prefer, have, use and refuse different types of technologies to communicate because, among many other reasons, there are important advantages and disadvantages in the use of each technology.

Telephone, Fax, IP-Phone, voice-mail, IVR systems, PBX, mail, email, Web, WML, HTML document, video-streaming, internet, video-conferencing, ActiveX, MPEG, WORD, PDF, MP3, DVD, Browser, are just a few words or acronyms that relate to technologies used in synchronous and non synchronous communications. Some new technologies will come and some will go.

It is expensive and time consuming to support, manage, keep up with technology changes and advertise for all technologies.

When providing information on how to reach an individual it could open the door for SPAM, Telemarketing or in general undesirable communications.

Some resource that allow synchronous communications are rigid and do not offer common features that users are accustomed with phone systems like Call Center, IVR or Voice Mail services.

People spend time trying to configure, and use those technologies, that often offer some overlapping functionalities. By integrating different technologies, it could be possible to be more efficient and to achieve some synergy.

From all previously mentioned technologies, the Browser for the Client side, and the Internet in general, is a good candidate to be the center peace in the integration of all different technologies. The browser gives a platform where different resources/applications provided by different competing vendors can be used to get data and communicate in different ways and formats. Most likely in the future it will be possible to communicate through a Browser in synchronous and non-synchronous ways covering all of our senses (sight, hearing, touch, smell, taste). The decision to upgrade or add features is made easier by the fact that upgrades are related to specific inclusions of new resources. The use of the Browser is wide spread and the port 80 is open in most networks, and most people are connected to the Internet.

There are limitations when communicating through a Browser. The browser is not interactive in nature, the client side is in charge of GETting and POSTing information, and the server side just waits to reply to those commands. In addition, the mentioned resources, that allow additional features, communicate with other servers that are not necessarily integrated to the web server.

By talking already about servers, most likely what comes to mind to some people, and rightfully so, is special computers in big corporations that require technicians to set them up and keep them running. It is not something that people assume they should have at home, as they have a phone system or an answering machine or even that their own personal computer could be considered a server.

The interests of those corporations that could run the mentioned servers might conflict with the interest of the individuals who need to communicate.

People, for whom money is spent to get to visit a web site, leave without giving any feedback; it is not possible to see current visitors to the site and have information about what software they have installed, what pages they have chosen to visit, and what responses or input to forms they have given; it is not possible to greet and talk to them as if they were in a real space; it is not possible to guide them through the site as a clerk could do with a potential customer in a brick and mortar store.

### SUMMARY OF INVENTION

The invention provides methods and systems for integrating and coordinating non-uniform communication resources using the Internet.

On the client side, the whole application has been abstracted using just Contents, Users, Sessions, Groups, and the relationships among those elements.

The Web base user interface displays those elements and their relationships in ways that simplify the management and understanding of the whole system.

Different types of resources could be configured following the same steps.

By simplifying the whole system with said four elements, it is reasonable to expect that any body could set up and configure the system by themselves, and be able to have a server at Home, with their own web server, email, voicemail, surveillance and other systems integrated to it.

The server side collects information about the Users resources and stores that information in the respective Session and/or User records. The server deals with the fact that different Users have different applications/resources installed, and that they require communicating with different types of servers. It provides a messaging system to integrate server side processes.

Communications are managed by displaying Content; wherein displaying is the process of sending for each Session involved in the communication a personalized Order, built according to the resources available to display the Content, the servers available to provide said Content, and any other data stored into the system related to the Content, Session, User and Group involved. When said Orders are executed, Commands are sent directly or indirectly to the resources available for the respective Session.

One embodiment of this approach particularly enables to have bidirectional communication through a web site and using the web site for the reception of people who then can communicate with other people in synchronous and non-synchronous ways.

Even with the basic client side resource, a Browser, it is possible to communicate without forcing users to buy, install and/or configure software. Of course, with additional resources like Plug-Ins, ActiveXs, Java-Applets, applications and even Hardware the possibilities of communication increase.

The system provides an infrastructure to create diverse communication solutions like the following: (a) A point of entry to servers and services running in a private Intranet. There are two good examples: a Surveillance System, and a phone answering system. The first is an example of accessing IP services in an intranet, providing additional security and offering a unified system to control them. The second is an example of services that do not use the Internet, and even historically have not run on computers and still they can be integrated in to the system.

(b) An SMTP server, voice mail system, or other servers integrated with private/personal data at home or at the office allows among many other things to send different types of messages to groups of people according to their preferences, and to set rules for people who want to communicate and avoid SPAM, telemarketing and other undesirable communications.

(c) A personal or family web server as the standard way for the reception of people for synchronous and non-synchronous communications with members of the family. With this solution integrated with previous one, it is possible to reduce undesirable communications to zero, and even penalize them. It also offers a way to be reached anywhere in the world no matter how many times members of the family change location, jobs or communications technologies.

(d) Web reception. When the site is built using Content the selection of links or the move through the site and the responses or input from forms done by a visitor could be easily tracked and used to get to know more about the Visitor.

Since the browser becomes a two-way communication system it is possible to establish a live communication with a visitor to a website, and of course the other way around, a visitor could request to communicate.

Information about the visitor can be used to make the decision to start a live interaction with him or her. Once there is a conversation with said visitor, he/she could be transferred to talk to other people connected to the site as considered convenient. Communications with said visitors take place in virtual spaces represented by Groups. Rules, policies, and features beyond the accustomed in phone systems could be programmed in a very flexible way based on specific relationships among Sessions, Users, Groups and Contents.

(e) Special personalized communications like a Teachers page. Students once they log in at their teacher”s or their School”s web site, they can see the class where they are enrolled, and for each of them see curriculum, notes, and own grades or turn in assignments.

The same Teacher page could be used to keep parents informed about their kids and their performances. The page displays according to the person logged in, and a parent could see information not accessible to their kids, for example.

(f) A grading/evaluation system. The teacher using the Content-Monitor-View that displays the Content-Questions against the Users in a Group-Class can then evaluate some answers; the system could grade some others automatically and calculate the final scores.

(g) An on-line teaching system where classes can be prepared in advanced, and the Content to be used can be cached in advanced to the Users' local machines liberating bandwidth resources at the moment of an on-line class. The meeting place is the web site itself.

The Teacher has the flexibility to use different resources and contents, provided by competing vendors to communicate in synchronous ways with the students. By using the mentioned Matrix that displays the Content-Questions against the Users in a Group-Class, the teacher can send questions to all or individual students and see their responses and grade them live.

By using the four basic elements that simplify the management and the set-up of the system, and by integrating different types of servers and applications in a symbiotic, synergetic fashion, this invention allows having at home a system that allows more control, efficiency, flexibility and wider spectrum of possibilities to communicate with people.

### BRIEF DESCRIPTION OF DRAWINGS

The features and advantages of the invention are better understood by referring to the following detailed description, which should be read in conjunction with the accompanying drawings:

FIG. 1 Illustrates how different resources of the system interact with each other.

FIG. 2 Illustrates how the Client Resources interact with the system and with each other, particularly how a Browser becomes a two-way communication resource.

FIG. 3 Illustrates a flow diagram of a request to a Server integrated to the system when providing Content.

FIG. 3A Illustrates a flow diagram of a request to a Server integrated to the system when receiving Content.

FIG. 4 Illustrates a flow diagram on how an XML-Builder API call is handled.

FIG. 5 Illustrates a flow diagram of a message processed by the XML-Processor.

FIG. 6 Illustrates the DTD for the XML-Processor programming language.

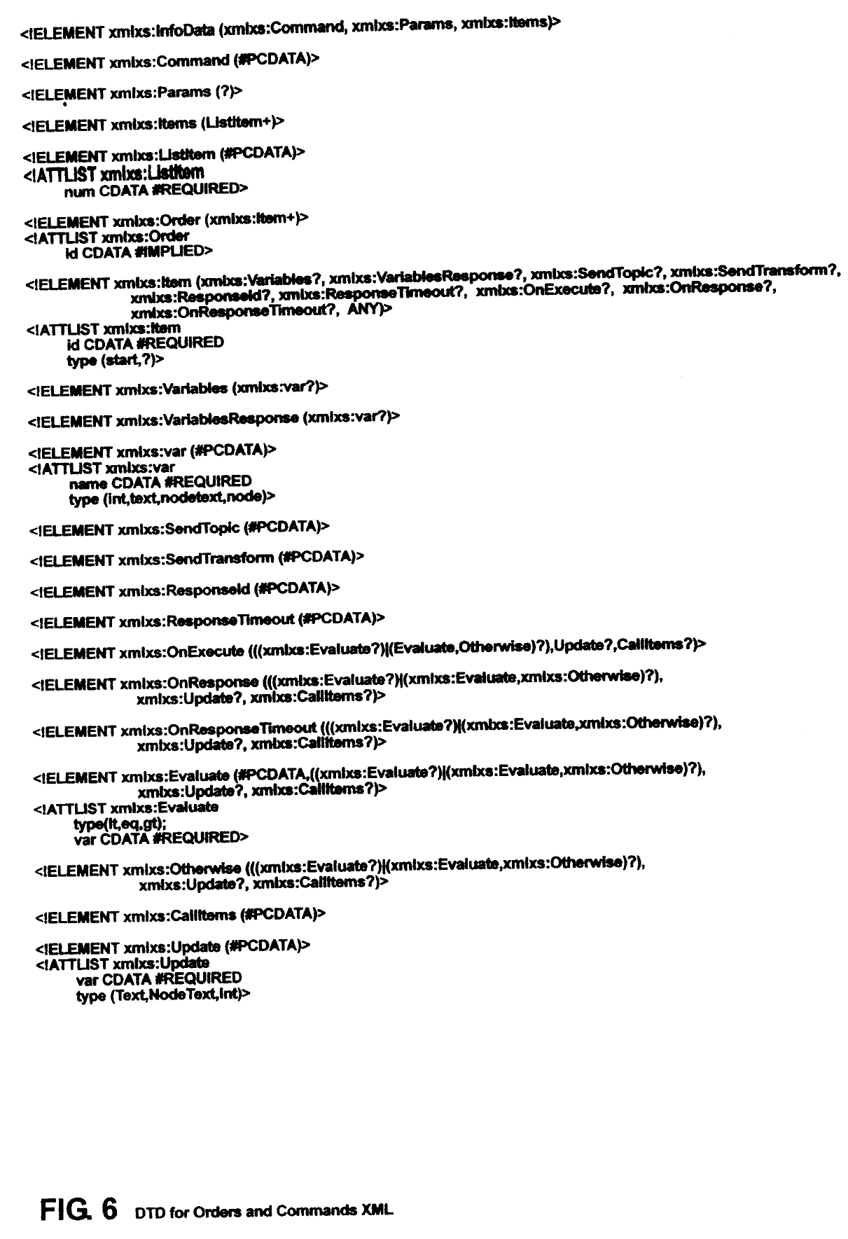

FIG. 7 Illustrates a diagram of Content vs. List of Sessions or List of Users view.

### DETAILED DESCRIPTION

The present invention relates to computer methods and systems for integrating and coordinating different communication resources using the Internet. It particularly enables to have bidirectional communication through a web site and using the web site for the reception of people who then can communicate with other people and devices using Content in synchronous and non-synchronous ways.

1. Elements

Following is the description of the four basic Elements used to facilitate the understanding and the management of the system: Session, User, Group and Content.

1.1. Sessions. Sessions are created every time someone connects for the first time and ended after a timeout without connection to any server integrated to the system. Synchronous communications work with active Sessions.

SessionId is a key used at the server side to Group all the resources connected directly or indirectly to any Server from one single computer.

It is a function of any server integrated to the system to identify the Session in a connection.

1.2. Users. A User is a known individual, a Session that has logged in. For non-synchronous communications, the creation of a User account is required.

When a Session loges in, the Session belongs to the User, and the configuration set for the User takes over the Session configuration. Normally, through out history, a User will have had started different Sessions, not necessarily from the same computer, and not always with the same resources.

After login, the session holds the history of the activity of a User during an uninterrupted time.

1.3. Groups. Users and Sessions could belong to many Groups. A Session is transferred to a Group; a User is included in the Group.

Groups are used to communicate simultaneously with many Users or Session. Communications could take place outside a Group, but preferably, all Communications should take place in a Group even if it is just between to parties.

Groups are used in a very flexible way. For synchronous communications, there are Groups of Sessions, and for non-synchronous communications, there are Groups of Users. For example a Group “IS Class” could be used to transfer all the Sessions participating in an on-line “IS Class”, or could be used to work with Users enrolled in the “IS Class”, who may be currently in a Session or not, and grade their assignments or send them Content in non-synchronous ways.

A Group of Sessions could be understood as a phone extension enabled for conference call. When Sessions are transferred to a Group, they might go to an on hold state first. Someone with the proper rights in the Call can accept the Call by accepting the transfer to the Group.

When for the first time two Sessions simultaneously are in a Group a Call/Conversation is started. When only one Session remains in the Group, the Call/Conversation ends.

Groups could be made out of more groups also. If a message is sent to a group, all the members of the group and recursively, the members of the child-groups get the message, but avoiding sending duplicated messages. For example if sending a message to parents of kids in the “Spanish” class and in the “Math” class if a parent has kids in both classes he/she will get just one message.

1.4. Contents. Content is data or reference to files or data that could be used by a resource. The data can be static, or can be generated dynamically. For example, a Content could be just a reference to a streaming video that is being broadcasted live.

All contents have an entry in the database. They have a name, a description, in some cases a reference to a file that is the content itself and an XML document that holds additional information.

Contents can be created, imported and/or cloned.

To import Content, a file is uploaded to the system, and a Content is created in association to that file. For example, an HTML-page and the objects it references with relative URLs, all need to be up-loaded to the system so that the page can display correctly. Usually only the HTML-page will need to be a Content itself and when displayed the displaying Resource will retrieve the objects it contains according to the relative URLs for those objects.

There are different Content-Types in order to facilitate the creation, and the edition of Contents with specific characteristics and with a specific set of Display-Options available. All contents that can be created by the system are in general XML contents.

Questions, Mailboxes, POP-Account, Publication, Payments, Products, Conditional Include, Questionnaires, Menus, Classes, XML and Alarms are examples of contents that can be created with the web-based User Interface.

XML-Contetns, and XSL-Contents can be created by the system, and the User clones and/or edits them to modify some displaying properties. Cloning is also useful when trying to Post contents more than once. The system does not allow a Content to be posted more than once to the same User.

Each content type has in the configuration file an XSL for editing/creating that transforms the XML-Document part of the database entry in to an HTML Form to facilitate the understanding by an end user. Also an XSL to transform that same XML-Document for display. The first XSL allows creating a Content-Question for example and the second allows displaying that Question.

It is possible to add more content types by just adding a new entry with the respective XSL-Contents.

Following are examples of some Content-Types embodiments currently used in the system:

1.4.1. HTML and standard contents. Any HTML page with any embedded objects, ActiveX, applets, or images. For the page to display correctly all elements with relative URLs need to be uploaded to the system but they do not need to become Contents. There are also Content-Type-Image, Content-Type-Audio and Content-Type-Video used when those Contents want to be displayed alone without being in the context of the HTML page.

1.4.2. EMail. EMails are references to “.eml” files or individual email messages. It also holds meta information regarding the Email.

1.4.3. Message. Messages are ASCII text. This text messages could be sent to different devices, like an electronic bulletin board on the road or an application for chatting. It is the simplest content that can be created by the system.

1.4.4. Question. Question-Contents require a response when displayed. A question could be Radio (1 of many), Check (many of many), Numbers (exact or in a range), Words (exact for a set of valid responses), Date, Open-ended, or Assignments that require a response with a file or a response with a Content.

Some questions can be automatically evaluated by the system and some questions require to be manually evaluated by a human being like in the case of Open-ended and assignment questions. All questions can be manually evaluated, and the manual evaluation overrides the automatic evaluation.

1.4.5. Alarm. The main characteristic of an Alarm is that it is displayed together with its Childs only to the owner (or creator) of that alarm, as opposed to all other Contents where the Child Contents are displayed to the original display target Session.

An Alarm could be used to inform the Alarm Owner that a Content is being retrieved by adding the Alarm as a Child to the Content that he/she wants to know when it is visited.

The Alarm Content collects additional information regarding the type of notification to take place, and the Display-Option for the Alarm makes use of that information. Usually the alarm has child Contents, like sound that physically notify the owner.

1.4.6. Conditional. Conditional-Content offers a mechanism to include Child Contents based on SQL statements at run-time. It has a way to define an SQL statement and indicate the database and the XSL to be used to transform that query output.

It is used to personalize the selection of Contents dynamically based on any type of information in the Session, User, Content, Group and any other Table of the Data Bases of the system.

The XML output of the SQL statement is transformed with the indicated XSL, and then the XML-Builder extracts the Contents from that output and replaces the Conditional-Content with the extracted list of Contents.

1.4.7. XHTML. XHTML is an HTML that follows the XML rules. A Display-Option transforms all the Contents Grouped to be displayed at the same time, therefore an XHTML could work together with Question-Contents for a special look of a group of questions. There should only be an agreement between the XSL of the Display-Option and the XHTML on how to relate to each other.

1.4.8. XML. XML-Contents are key in the functioning of the whole system; they usually refer to dynamic pages like JSPs or CGIs with some additional parameters. When the XML is displayed, the dynamic page is called including those parameters.

The system generates automatically some XML-Contents. Users can clone those Contents and/or edit their parameters to modify their look or behavior. Those Contents can be used as a reference to create XML-Contents from scratch, by creating the dynamic page, and then creating the XML including relative URL and the desired parameters.

In an embodiment of an XML-Content, you could have a Questionnaire and all the Questions for all the students in a Class in a Content-Monitor-View. You could then: (a) grade each response and display the grades to each one of the students. You do not want the students to be able to modify the grade you gave (is just an informational page: “here are your test results”).

(b) let the students grade each other. You do want them to be able to set the grades.

Both are possible with the same dynamic page that can be called by displaying an XML-Content, one with parameter

<enablegrading>yes</enablegrading> and the other

<enablegrading>no</enablegrading>. (a) is generated by the system using the Content-Monitor-View; (b) has to be edited.

XML-Contents are used to integrate embeddable objects, ActiveX and Applets in to a communication solution. For example, an XML-Content when displayed could include a Netmeeting ActiveX with the right parameters to communicate with the Session that sent said Content. By cloning that XML-Content and editing it, it is possible to use this new Content to open a communication to the Session that started the conversation, not the one sending the Content.

XML-Contents could be useful to integrate with other applications. In one embodiment, XML-Contents are used to integrate with an appointment application. The XML-Builder provides functions to access the appointment system. An XML-Content is used to display an Appointment-Schedule-View by passing the right parameters (like, User providing appointments, User asking for appointment, range of dates, range of times, type of appointment) to a dynamic page that in turn passes those parameters and an XSL to the respective XML-Builder function. The User asking for an appointment can then select and set the appointment according to the interface.

XML-Contents are useful to customize pages for a User. For example, teachers could have references to some XML-Content in their Home pages that provide only the features they want to use.

(a) Set of Content-Monitor-View XML-Contents with List of Sessions (students) in “my class” vs. Contents to be used in each Class.

(b) Set of Content-Monitor-View XML-Contents with List of Users (students) in “my class” vs. Contents to receive students to “my class”.

(c) Set of Session-Monitor-View XML-Contents with additional Groups to organize and work with students in sub-groups.

(d) Set of Class-View XML-Contents to organize information for the Students in class web pages.

(e) Set of Content-Monitor-View XML-Contents with list of Sessions (students) vs. XSL-Contents to execute processes like enrollments or payments.

(f) Set of Appointment-Views for the different types of appointment she/he provides like discussion of problems in class and tutoring appointments.

If a specific XML needs to be created by end users on a regular basis, it is best to create a new Content Type, with the respective XSL-Contents and make it a more user friendly Content.

1.4.9. MAILBOX and POP-Account are examples of XML-Contents where it made sense to create new Content-Types for to facilitate the usage by end Users. The Mailbox-Content holds information about how many days a message should be kept, what notification Content to display when a message is added, if an incoming message should be rejected or not and more.

1.4.10. PAYMENT. It is another example of an XML-Content that allows the capture of data relevant to a payment.

1.4.11. PRODUCT is another example of an XML-Content. It usually has other Content Childs like for example: Pricing-Policy-Content; Payment-Content; Content-Images with views of the product; and Content-Audio with music and advertisement. It holds product Id used in the Product database.

1.4.12. XSL. XSL-Contents are used extensible in the application. JSP generate their HTML output by requesting to the XML-Builder XML documents and indicating an XSL to transform said document.

XSL-Contents sometimes are used to generate Orders when displayed, and they could be added in Relationships in specific Rolls.

For example, an Agent sends to a student an XSL to process payment to enroll in class X. The system automatically will ask the student the appropriate questions (sending questionnaires and forms), process the questions (validate the information), process the payment and sends a “done-SUCCESS” or a “done-FAILED because” message to the Agent, meanwhile the Agent could have dealt with many other students.

To trigger process database changes. A teacher wants to submit the final grades to the School system. He she could clone the XSL-Content for submitting grades, and replace the Questionnaire-Content that holds the final grades in the Cloned XSL and then post that XSL-Content for all the Students in the Group. The XSL-Content will send the grades to the School System, represented by a virtual User.

Reports can be created with XSL-Contents. Someone with some knowledge could download an XSL content, modify it and import it in to the system to be use as the XSL-Content to produce the body of a new Report.

The same is valid for new Content-Types, and the XSL-Contents needed to edit and display them.

1.4.13. Questionnaire. A Questionnaire-Content should have at least Question-Contents as Childs. Holds information regarding timeouts and general instructions.

1.4.14. Class. A Class-Content has different types of Contents as Childs to be used to communicate. It also provides a way to organize Content. There are several uses for Class-Content in Relationship to Users, Sessions and Groups. A Class-Content could be used to add Product-Contents and it works as a traditional chopping cart or product Order.

1.4.15. Menu. A Menu-Content has any Contents as Childs to be used in the structuring of a web site with menus. It is common to have other Menu-Contents as Childs that represent sub-menusThe Menu-Content could add: XSL-Contents to personalize the look of the web pages and the presentation of menus and submenus; Conditional-Contents to personalize the menus and sub-menus of the web site according to the User visiting the site.

1.4.16. Conversation. A conversation is also a Group of Contents but built automatically by the system, not a User. Conversation groups all the Content generated or used in a conversation. A conversation is like recording a phone call: all Contents displayed in the context of a conversation are added to the Content-Conversation as childs. Every time there are two or more Users interacting in a Group, a new conversation is created. Conversations have the name of the Group with a timestamp.

1.4.17. Imported data. Imported data is a special content where a Comma-Separated-Value files or other exported file is imported to the system. The Content facilitates the import of that data into the database, avoiding duplications.

1.4.18. Publication is an example of a Content based on other contents. Instead of having its own XSLs, it uses a Content-Questionnaire to capture information regarding date of publication, ISBN, editor and so on. When the Content is created or edited, the Questions are displayed. The responses to those questions are the Content itself.

1.5. Content Formats. One Content could have different formats. When Contents are created or imported, they are transcoded in to different formats and sizes according to the available server side capabilities and system configuration, by sending Commands to the transcoding applications.

When transcoding is completed, the Content-Format tables are updated also. For example a JPG when loaded as an image, it is resized to three different sizes. An MPEG 320×240 movie could be transformed to a MPEG 160×120, and QuickTime or Real.

2. Relationships

In order to organize and to modify features, Relationships among Contents, Users, Sessions, and Groups are established. Some rolls are unique; some rolls allow different Contents to play the same roll.

Some rolls could have a Content-parent, where new entries are added for a menu. For example, a content called all states could be the parent of the roll State for a User and Group. When adding a content in the roll state for a User for example, there will be an option to select from previous entries, or add a new one.

Rolls could be grouped according to their function, some are related to address, mailbox, cv, synchronous communication or something else. According to the User privileges, people could or could not see or edit roll in those groups. Some groups can overlap if considered necessary, for example: group of rolls related to public addresses, and group of rolls related to public and private addresses; some people have access to home phone numbers and others won”t.

2.1. Content to Content. Contents can have Content Childs and the Childs could have more Childs, the system just checks for infinite loops not to be created. When displaying a Content the Content and all the Childs are displayed. For example, a Questionnaire-Content has Question-Contents as Childs, when displaying the Questionnaire-Content all the Question-Contents are displayed also.

When a Content is added to another Content there is the option to indicate if it is grouped or not, a space for a Reference string and a value weight.

The Reference if used will be added to the parent's reference after a dot.

Like “2.1.” means that the parent is reference 2 and the Child is 1.

All Contents grouped will be displayed together; if they are not grouped, they are displayed sequentially according to the reference.

Each Content could have a timeout, where if there is a timeout in one of the Contents displayed in the group, the display of next group of Contents is done after the timeout. One embodiment has three different types of timeouts: No timeout, where user will display next group when she/he presses next; maximum time, where user will have a maximum time to press next and if time elapses the system will go to next group automatically; and at timeout, where only the system will display next group at timeout with no option to go faster.

The Value Weight is used calculate final grades, or in the case of menus to indicate a special roll of the Content in the list.

Questionnaires, Menus, Classes, and Conversations are examples of Contents that by their own nature have Childs, but all Contents could have Childs and parents, for example: A Question-Content could have an Audio-Content or a Video-Content as Child and when the question is displayed, the User will hear or see the video or audio also. In this case, for example the Question could be displayed through an IVR (Interactive Voice Response) system without requiring server side text to speech capabilities.

A Video-Content and Audio-Content could have an HTML-Content as a Child to offer a written description and explanation of the video or audio or the opposite.

An Image-Content could have an Alarm-Content as Child, so whenever someone gets the picture, the owner of the Alarm-Content is notified.

There are many good uses for adding Contents with Childs as Childs of other Contents, for example: A teacher has given a few tests to a Group with Questionnaire-Contents. At the end of the period, he/she chooses the ones to be considered for the final grade and adds them to a new Questionnaire-Content called “Final Grade” as Childs. Then he/she gives some value weight to each of the added Questionnaire-Contents, and the system automatically calculates the final grade for the students enrolled in the Group/class.

A teacher is preparing the students for the final exam. He/she could do a summary of all the previous classes by choosing the most relevant Content and add those to a new Class-Content. At the moment of the Class, the teacher has all the class material handy to be displayed to the students.

2.2. Content to Session. It is recorded automatically by the Servers of the system and the XML-Builder every time a Content is requested, displayed, downloaded, replied etc. It establishes the history of the use of a Content by a Session in an XML document stored in the Database.

2.3. Content to User. The Content to User relationship is achieved indirectly through the Session.

For non-synchronous communications, posting messages, the system establishes a relationship between the User and the Content and the Content itself with the Mailbox-Content.

2.4. Content to Group. This relationship usually is date sensitive and therefore has the option to indicate a date.

Conversation-Contents are created automatically by the system. Every time one Session is in a Group, a conversation is created. If one Session is left alone in a Group the conversation is closed, and a new conversation is created.

The Conversation-Content will be the parent of all the Contents used to communicate among the members of the Group where the conversation is taking place, and a relationship between the Conversation-Content and the Group is established and the date of the creation is set.

Other Content-Types could be added in relationships to a Group like in following rolls:(a) Synchronize. Usually Class-Contents, to provide a way for Users who have a Client Application to download to their local machine material related to a Group-Class.

(b) Class. Usually a Message-Content or an HTML-Content that summarizes the class to take place, but it could be a video, audio etc.

(c) Assignments. Usually Question-Contents, to indicate when assignments are due, and provide a way to turn in those assignments.

(d) Notes. Any type of Contents related to materials shown or handed out in a class to be kept as reference material for that past class.

(e) General. Any type of Group to Content relationship that is not date-sensitive. Like status of final grades, an XML-Content to Schedule appointments, or messages for a substitute teacher regarding the class.

All these relationships are useful in building new Web pages for Groups' home pages, like the Teacher”s page.

2.5. Roll Content to User. Contents in specific Roll are used to customize settings for a User. Specific configurations of the system could add as many rolls as needed.

Contents in specific rolls are key in the integration with other service.

Some of the rolls that come in an embodiment of the system are for example:(a) Street, City, Zip, Country, Phone, Fax are rolls that could come standard in the system. In a particular set-up, it might be necessary to add Pager, Home-Phone, height, shoe size, publications, URL, CV, language or whatever.

(b) Picture-id, the picture that visually identifies the User in the Application.

(c) Alarm for calls, to indicate a specific way to inform the User that someone wants to reach him/her.

(d) Greeting—Not available, leave a message. A greeting for someone who wants to reach him/her and he/she is not logged in the system.

(e) Greeting—Busy Please hold.

(f) Greeting—Busy, leave a message.

(g) Private Comment—Messages entered by a sys-admin that are not visible to the User.

(h) Inbox for Messages of Not Known senders, Inbox for Messages of Known senders, and Inbox for Messages without a return address, to indicate how to redirect incoming messages according to those properties.

(i) Mailbox accessible trough the web interface roll. Could be more than one. If a Content in this roll is also in the roll for Inbox for Messages of Known senders, then the User will be able to see through the web-interface those messages, if not it wont be possible.

(j) Mailbox accessible trough POP. Same as previous, but to indicate that mailbox should be accessible through an email application for that specific User.

(k) Pop Account to retrieve messages from other sources through a POP protocol.

(l) Get Mail Account to get somebody else”s messages. For example to control kid”s email: if the kid does not have access to their own Inbox for not known users, and the parent does, he/she could transfer the message to a mailbox accessible to the kid after authorizing it.

2.6. Roll Content to Session. Contents are used to customize behavior and representation of the Session: (a) Picture-id.

(b) Private Comment. It is helpful in synchronous communications, when Visitor interacts with different people.

2.7. Roll Content to Group. Contents could be added in relationship to Groups, for example:(a) Some of the roll of the User could be used in the Group also. For example in a Group-type organization having the address rolls will allow to have the address for current and future members of that organization. When printing labels for example, if there are no entries for a User directly, but there are the address entries for the group, the label is printed using the group information.

(b) Home Page, default home page for the Group.

(c) Welcome Message, Contents to be displayed when a User enters the Group.

(d) On Hold Message, Contents to be displayed when a User enters to an on hold state for the Group.

In one embodiment, a teacher could have a new Class-Content in the Welcome Message for Group (class) with for example a following Content Childs: an HTML-Content with the general notification that the Session has been accepted to the class; the respective Audio-Content; an HTML-Content with a summary of the class; a Question-Content to gather assignment due the day of the class.

In one embodiment, Group with name “reception” is created. Said Group has as the On Hold Message an XSL-Content that produces an Order that works as follows: Sends Command to Execute a query to find what Agents (Users) are available to handle calls in the “reception” Group; with the Response of the query displays each Agent the respective Alarm-Contents notifying that someone is on hold; Creates and displays a Message-Content to said Session with information regarding his/her position in the holding queue and the quantity of Agents available to receive calls; On Timeout displays said Alarm-Contents again, and displays another Message-Content to said Session indicating that is doing so; If call is accepted, known with a response to a Task signaling that said Session was transferred manually from on Hold to a Group, the Order is terminated; If call is rejected known with a response to a Task signaling that said Session was transferred manually to null, the Order displays a “call was rejected” Message-Content to said Session and Order is terminated; after 3 unsuccessful tries with no answer, Order is terminated and displays a “sorry try again” Message-Content to said Session.

Said XSL-Content in the Roll of On Hold Message is useful to handle help requests from Sessions, by transferring said Sessions to the “reception” Group with transfer privileges equal to zero. If a Session is transferred without privileges, it goes to an on hold state for the Group and the Content in the On Hold Message Roll is displayed for the Session.

By editing the XSL, the behavior could be very different. So probably, when a Group is created the XSL used to receive transferred call from the Group with the closest behavior desired for the new Group should be cloned, edited and added to the Group in that specific roll.

2.8. Group to User. It is used to enroll Users in a Group. Sessions belonging to Users who belong to a Group have special privileges to join the Group.

For example, when a Session is transferred to a Group (Call) if the respective User belongs to the Group he/she will be accepted to the conversation, if not he/she might go to an on Hold state first.

For communications with groups of people: a message sent to a group is sent to all the Users belonging to the Group.

In the User interface, it allows to let someone work with a specific group of people and for example grade their answers.

Groups are important for the creation of personalized pages, like the Teachers Page. The page will be available just for users who belong to the Group that includes all the people enrolled in the Class.

Groups can be used to represent companies, organizations, universities, families, and child groups could be understood as their departments or the next generation.

In the Group to User it is possible to enter additional information like:(a) Position: the position could be job related, like job title; education related, like B.A or PhD. in a group representing a University; or others like parent child in a group representing a Family. A User can have different positions in the same group.

(b) Beginning and ending date: help to keep historical information.

(c) Status: to indicate if the membership is current, ended or if it is “The Current” or “The Contact” for the Group.

(d) Comments: for additional information.

Positions, on the other hand can be grouped, and that information used for reports.2.9. Group to Group. Groups could have in a recursive way child Groups. All the users in the child groups belong to the parent Group.

For example, a message needs to be sent to Parents and Teachers; a new group can be created that has both Groups as Childs; some Teachers are also Parents; all will get only one message.

2.10. Group to Session. Sessions are not exactly added to Groups, they are added to a Session to Conversation-Content table and that Conversation-Content is in the Content to Group relationship. The relationship is not direct.

3. Resources

Resources are any devices, applications, programs, ActiveX, embedded objects that could receive directly or indirectly (through another application) commands to perform an action related to using Data. The Resource's only required action is to connect to a server directly or indirectly to retrieve that Data. Delivering a command could entail setting properties, calling methods or functions, or triggering events in the resources. Delivering a command includes instantiating, initializing, running or calling the resource with the respective parameters or arguments.

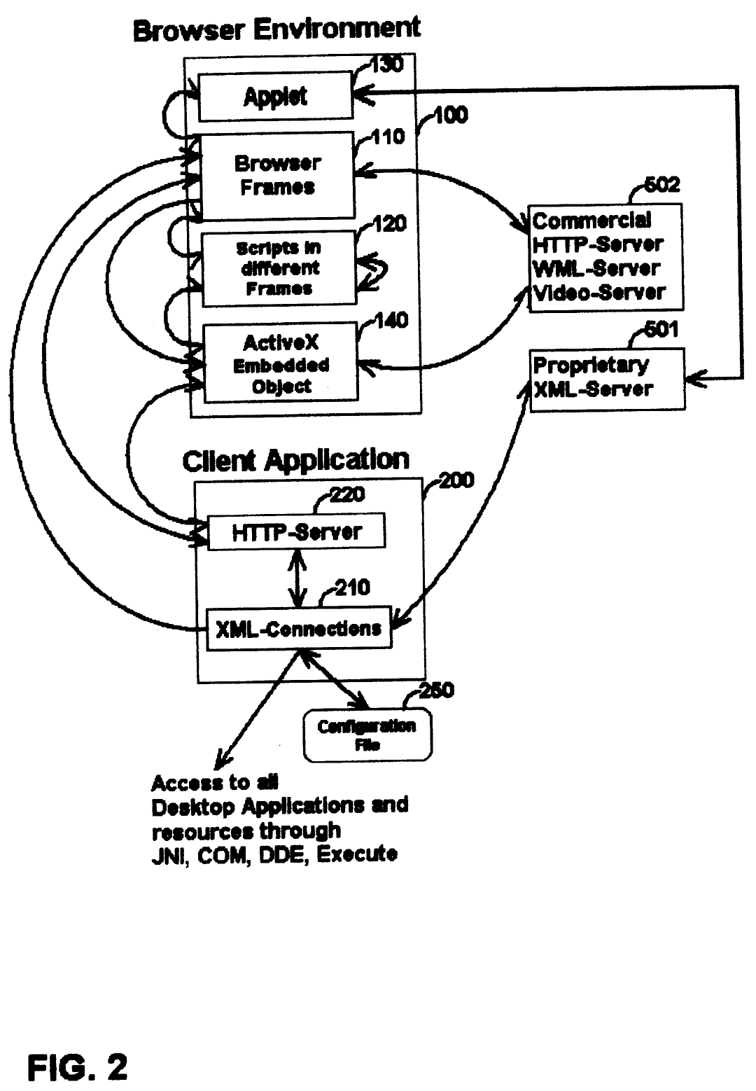

FIG. 2 Illustrates how a Browser becomes a platform for different resources to run 100, and how those resources in the Browser environment communicate with each other, the servers 500 and the Client Application 200. Of course, many more resources could work with the system like hand-held devices, but in general, the steps and the descriptions of the processes would be very similar if not the same.

The Browser could be any Browser, like any version of Microsoft I Explorer, and most versions of Netscape and others. A Browser connects to an HTTP-Server. The Browsers provide an environment were a plurality of objects could be instantiated, and those objects could establish TCP connections to a plurality of Servers 500 to retrieve data using different protocols.

Normally a Session would be created when for the first time the Browser 110 connects to the HTTP-Server of the system when the web site URL is entered manually in the Browser's navigation bar. In an HTML response, ActiveX objects, Embedded objects 140, Applets 130 and or scripts 120 could be included and the Browser instantiates those resources. One embodiment of an Applet 130 establishes a permanent connection to the XML-Server for a two-way communication. The commands sent back and forth are XML documents. One command indicates the Applet to execute a showDocument( ) used to open or reload a new Browser's window. Those windows can be referenced by a name accessible from the Applet environment and Browser's scripts environment.

The scripts 120 can access scripts in other windows, and sometimes they can communicate with the ActiveX and Embedded objects 140 through properties, methods and events.

3.1. Browser. The Browser is the basic Client-Side resource. With just a Browser and no plug-ins, it is possible to have a simple communication with text, documents and images, because the Browser can be used as a two-way communication Resource.

Usually, a Browser is a one-direction communication system: The User indicates the Browser when to send a request and then it receives the corresponding HTML-response.

The system makes a Browser a two-way communication system, by embedding in the HTML-response messages for the User. This is achieved by merging the HTML produced for the response and the HTML produced from all the XML-messages for that User's Browser. The messages are according to the Browser's capabilities.

There are several options to force a request without waiting for a User's indication. Among those options are: (a) use HTML-Tag <META HTTP-EQUIV=“Refresh”>; (b) use an Applet that maintains a connection to the system all the time, and when a message to the Browser is sent, another message is sent to an Applet to execute showDocument( ); (c) use of Client Application, and when a message is sent to the Browser another messages is sent to the Client Application for a DDE call to the User's Browser.

Messages for the Browser have a Name, Body and Header, so that only one Body is added and all headers are added for all messages with the same name and it is expressed in the instructions for merging the documents.

All the XHTML/XML documents from request's output and messages are merged according to script, link, title, meta and body tags of HTML standard expressed in the instructions for merging the documents.

The final HTML document will include the messages in the form of text embedded in the HTML page and/or script functions and script function calls.

The capabilities of the Browser could be defined by the User-agent, if the Browser is JavaScript enabled or not and has a java plug-in installed. All the capabilities are detectable and stored in an organized way in the Sessions image.

3.2. Browser's Plug-Ins and ActiveX objects. Plug-ins and ActiveX embedded in HTML-pages are Resources because it is possible to access them through the Browser by opening HTML pages with the right Tags and parameters so that the Objects retrieve the desired data. Some Objects expose some Properties and Methods that could be accessed through script increasing the communications possibilities.

There are a few Display-Options like DocumentViewer and Streamer where in a java and frame enabled Browser additional communication features can be used.

The Streamer, for example, shows a video in an embedded object in an HTML page in a Window/Frame of the Browser. People could interact with all others in the same conversation Group by synchronizing everybody's position in the movie with a single action.

Someone in the conversation Group has a video displayed with the Display-Option-Streamer. There is a Window Frame with an ActiveX or embedded object instantiated with the right URL and there is the respective script to read and set properties of that object.

When an User signals a synchronize action, the script reads the time position of the Object that is rendering the video and request from another window/frame in the Browser to display the current Content with the additional parameter indicating the position to all Sessions in the Group (but him/herself) with the preferred Display-Option Streamer.

The XML-Builder launches a display Order for each Session.

Each Order would be built according to the resources installed for the Session and there is no guarantee that all the Sessions would be able to display the video with the same Display-Option-Streamer. Assuming there is another Session in the Group with a java and frame enabled Browser; that Session Browser gets a command with a script function that checks if the video is being displayed or not by calling a function in a holder frame. If the video is not being displayed it opens a window to display it. If the video is being displayed it calls a function in the frame where the video is embedded that in turn calls a method of the Object to position the video in said position.

A holder frame is a frame that keeps information of all the other frames opened.

3.3. Java-Applets. Applets require the Browsers to be Java-enabled. There are different versions of java installed in Browsers. By being careful in the development of Applets, it is possible to maximize the percentage of Users that could have a specific Applet as a Resource.

An Applet is a Resource, not only because it is embedded in an HTML-page, but also because it can establish a TCP-connection to the server and sends and receives commands directly.

The Applet can communicate with the Browser because the ShowDocument( ) works within the environment of the Browser, and enables to open Windows in specific frames. The communication from the Browser to the Applet is not supported in many java plug-ins and Browsers.

The Applet can be used to push messages to the Browser if when sending a Message to the Browser another message is sent to the Applet to open a Window with an URL that will guarantee the reading of the Message sent to the Browser.

Applets could be used also as Resources that could add features for a richer Communication like an Applet based Chatter application or:3.3.1. PicturePlayer. PicturePlayer is an Applet that works as a Blackboard. It displays an Image on top of which is possible to draw objects or position a cursor. When the button send is pressed, every Session in the selected Group will display the same image, size, scroll location, pointer location and other objects placed on the image.

3.4. Java-Client Application. The Java application provides a User with the following capabilities: (a) Possibility to integrate resources in the Client Desktop like audio capture, video capture, other devices, other applications, and the file system not accessible through the Browser.

(b) Caching and Synchronization system. According to communication plans, like an in advanced prepared class, the system downloads large Contents to local directories; when the Content is needed, they can be displayed from the Client Application's Server not using bandwidth needed for other aspects of the communication.

Using FIG. 2, following are the steps that describe the Client Application as a way to access desktop resources:When the Client Application starts it opens an XML Connection 210 to all the XML-Servers 501, and according to the configuration file 250 it sends the User Identification for the respective server, and the list of resources available. There are two embodiments of the solution one works with the configuration file, and the other works with a database. There is a connection to a plurality of XML-Servers because the Client Application could be used to work with accounts in different institutions.

Said Client Application will use the connection to send commands to the XML-Server.

The XML-server creates a channel for the Client Application, and updates the tables in the system Database to indicate resources available for User.

The XML-server will have two threads for the connection: one to receive messages from the Client Application and process them, and another to read messages to the Client Application and forward them.

The Client Application communicates to the Desktop Applications interpreting the commands received and sending the events from those Applications.

Using FIG. 2, following are the steps that describe the Caching and Synchronization system.

Contents that refer to specific files are cacheable others are not.

The Client application sends commands periodically to get an updated list of Content that need to be cached. The list is build with all the Content for synchronization from all the Groups the User belongs to, and all the Contents posted to the User.

For each Content in the list, it establishes an XML Connection 210. The XML-Server 501 replies with file size, date and decoding key. If the Content does not exist in the local file system, or date and size do not match it continues with the downloading of the file in the following way: If date does not match it downloads the entire file, if the size does not match it continues with the interrupted downloading process. If the Content is already in the local file system, it drops the connection.

The Order when displaying a cacheable Content for a Session with the Client Application running will have the URL with the IP address of the Client Application's HTTP-Server 220 (default localhost port 80). The Browser will look for data in the local HTML-Server that comes with the Client Application.

The HTML-Server 220 for each request forces said XML-Connection 210 if there is no active Connection already downloading the Content. In said Connection, it also gets a key to decode the local file, gets a handle to the data and starts to send the data to the requesting Resource.

4. Server Side-Software and Processes Database.

The server side resources are a set of databases and applications that provide capabilities to be offered to the clients.

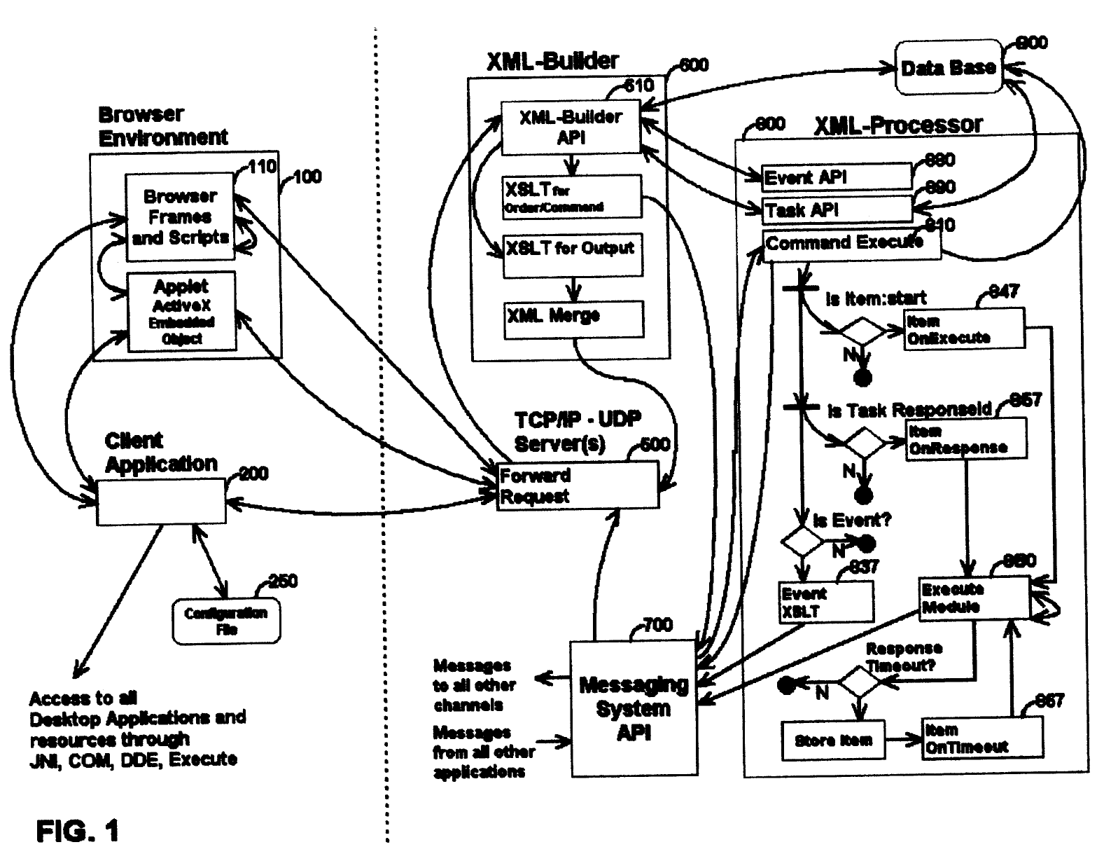

FIG. 1 Illustrates the different resources of the system. On the left side of the FIG. 1, the Client Side Resources are shown: Browser 100 and the Client Application 200, these resources are discussed under Resources.

The Browsers provide an environment were a plurality of objects could be instantiated, and those objects could establish also TCP connections to a plurality of Server 500 to retrieve data using different protocols.

Different types of Servers communicate with the XML-Builder and the Messaging System. Each server passes references to XSL-Contents, and instructions how to build from raw XML documents the final responses in a format understood by their respective Resources. There could be more than one call to the XML-Builder API in only one request to a Server.

The XML-Builder maintains connections open to the Databases 900 and uses JDBC or ODBC. All information regarding the status of the system, Sessions, Users, Groups, Contents and the Relationships among them is kept in the Databases.

The XML-Builder API 610 handles the sending of Commands and Orders to the XML-Processor 800. Some functions of the API return documents to be used in the Server's response, others build documents to be sent to through the Messaging System, and other functions do both.

The XML-Processor waits for messages sent to its Channel. With any new message, it checks if it is a Command 810 and executes the Command that could include some Database access and some sending of messages through the Messaging System 700 Then, the XML-Processor checks if the document is an Order, and if it is an Order it executes the OnExecute of the Items of type start 847; it also checks if the Order or Command matches a Response expected by any Tasks and if so executes the OnResponse 857 module of the respective Items/Tasks; and finally it checks if the document matches all the XPaths in the list of an EventListener 837 and if so transforms that document with the indicated XSL-Contents and sends messages to the respective Channel of the Messaging system 700, most of the time it would be an Order that would be sent to the same XML-Processor 800.

The XML-Processor has an Event API 880 and a Task API 890. The Task API provides a set of functions to list and remove Tasks from the Tasks list. Tasks are Items that were execute and had a ResponseId and ResponseTimeout nodes that indicated that a response was required. The Event API provides a set of functions to list, enroll and remove EventListeners. EventListeners are used to trigger events according to the characteristics of documents passing through the XML-Processor.

The Server side software uses publicly available technologies and standards like JDBC, JMS, CORBA, RMI, TCP/IP and HTTP. It incorporates known concept of Orders with Commands, Tasks, and Events/Responses. It has the flexibility offered in other solutions to integrate with different databases and software in a distributed environment, like accounting, transcoding resources, students' or any database, and other web sites.

The claims of the Invention are related to details of the interactions of the XML-Processor, the XML-Builder, the TCP/IP Servers and Resources based on the concepts of Session, User, Group and Contents on the Client side; and Commands and Orders on the Server side, making it easy and flexible to coordinate and integrate diverse communications resources.

Following are resources that are characteristic of this particular system:

4.1. TCP/IP Servers. Not all servers that provide the data referenced by the Contents need to be integrated directly to the system. There are different types of servers like commercially available HTTP, WML, and Video servers and others that could be proprietary like the XML-Server.

A TCP/IP Server can integrate with the system via RMI to both the XML-Builder 600 and to the Messaging systems 700. Most commercial servers could be integrated into the system, directly or indirectly. The messaging system could be any commercial product, but one embodiment of the system uses by default a basic Java Messaging Application.

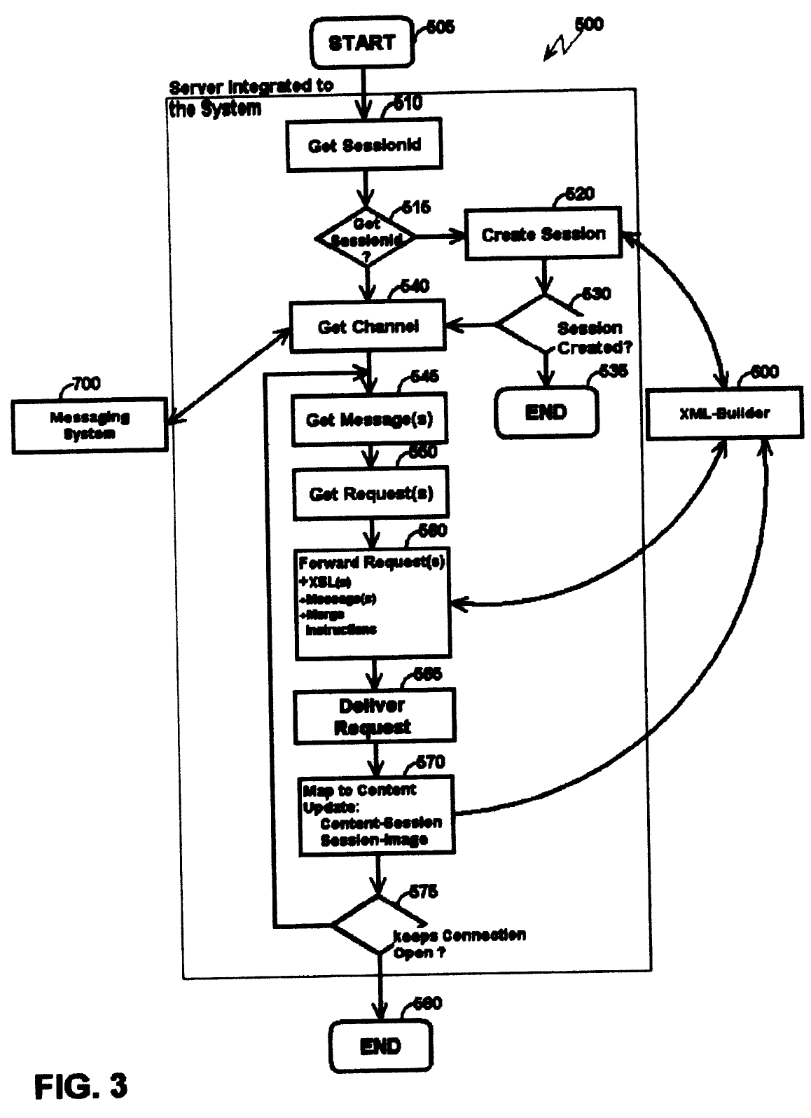

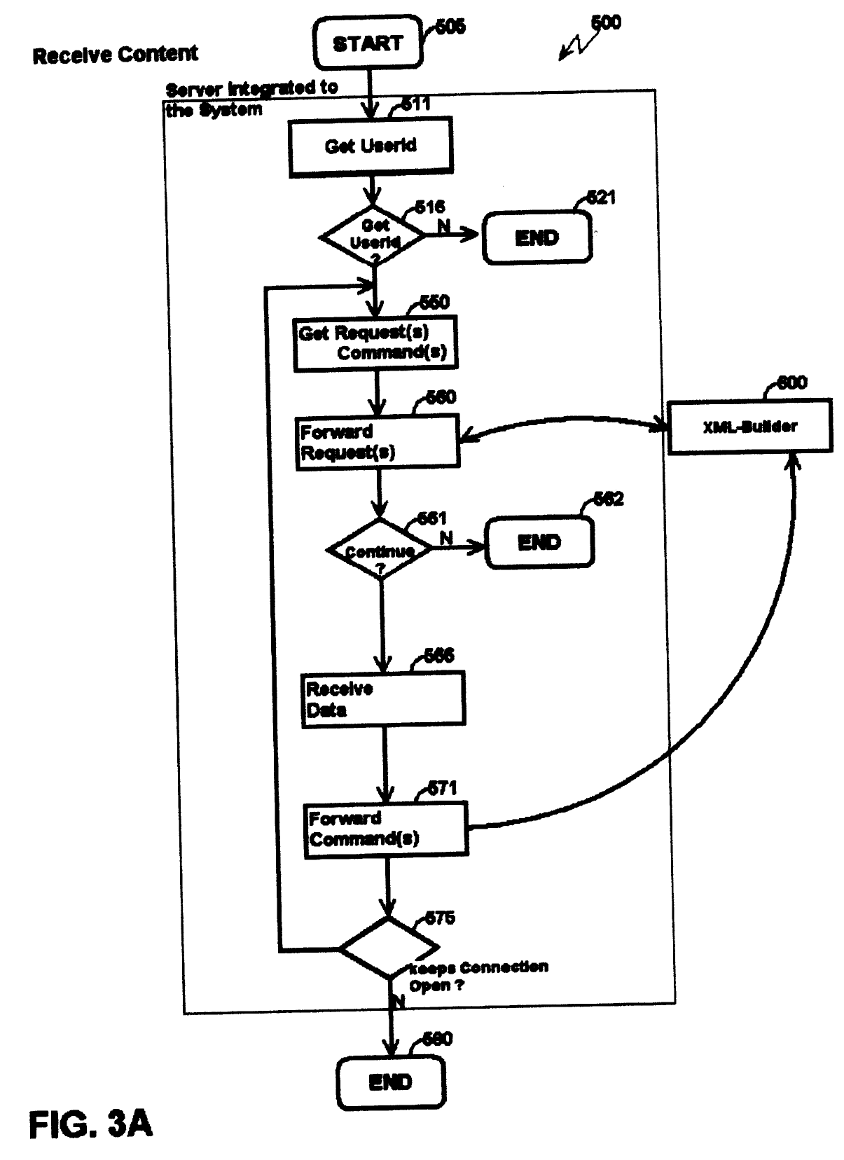

FIG. 3 Illustrates the steps that a Server Integrated to the System follows: A TCP/IP request from a resource is received 505; the Server according to cookies, IP address, host server, parameters or parts of the URL establishes the SessionId 510. If the SessionId is not identified it tries to create a Session using the XML-Builder API 520; if the Session is not created, because the information passed through the API is not enough to create the Session, or the Session should be rejected, the connection is terminated 535.

With the SessionId and the type of connection the Server gets the channel or creates a channel if it is not created 540. The type of connection is dependent on the type of service provided by the server and some parameters included in the request. In an embodiment of the system, some of the names used for Channels are WEBB[SessionId], APPLET[SessionId], XMLCLIENT[SessionId], and WML[SessionId].

Pipe refers to an entry in the Database to record the status of channels, making that information available to other components of the system.

All messages are retrieved 545 and the request is interpreted 550. It is a function of the Server to organize the information according to the XML-Builder API and make the necessary calls 560. There is a function in the XML-Builder API, where an XML document is built with a list of functions of the API to be called, their parameters, the XSL to transform each result and instructions to build the final response.

The response is delivered through the open socket 565. There is a mapping of the Content requested and once the delivery is completed, there is an update of the Session to Content table 570. Some Servers while delivering large documents update the Session to Content several times. If the request includes information about the available resources, there is also an update of the Session Image for available resources.

If the connection is to be kept open it will go back to get Messages and interpreter the requests 545.

One embodiment of the system uses multi protocol HTTP-WML-XML server for discrete and continuous connections with resources.

HTTP requests could be discrete: TCP connections that open get the information and close. XML connection could be continuous connections waiting to receive or send Messages to the resources connecting to it.

4.2. Receiving Servers. FIG. 3A Illustrates Servers integrated to the system that receives data that could be link to a Content.

An embodiment of an SMTP Server follows the typical Receiving Server steps: (a) User receiving an email is identified 511 (b) according to configuration continues or respond with error and terminates connection 521; (c) because the connection is following a SMTP protocol the Server identifies that there is an email delivery and that messages should be posted to User's account 550; (d) the request is forwarded to the XML-Builder 560, where the User sending the email could be identify with either their email address or the personalized receiver address and according to the configuration of the system it replies with a Mailbox; (e) according to the Mailbox properties it gets the message as a file 566 or it drops the connection 562;(f) it forwards commands to the XML-Builder to create or updated an EMail-Content link to said file, and to post said Content to User receiving email;(g) the User gets notified according to the Content entered in the Roll Content to User relationship for notification of messages posted or properties in the destination Mailbox; (h) if more emails are being sent then goes back to get the request 550. If the message is an outgoing message, the message is sent to an outgoing email queue, with the User ids of the sender and receivers and the Content id. When the message is sent it is transform according to the Users involved.

The System could be configured so that an User could receive emails according to the following address structures: x.u.p@server; x.u@server; or x@server; wherein “.” is any special character defined in a configuration file; and x, u, p are strings of any length of any characters or numbers not included as a special character in said configuration file; wherein x refers to the email-account field for the record of the User receiving the email;

wherein u refers to a unique Content in a specific roll for the User sending the message; and wherein p refers to an additional Content in the same roll for the User sending the message; wherein the sequence of x u and p is defined in the server configuration file as string: “x”; “x.u.p”; “x.p.u”; “x.u”, “x.p”; “u.x”; “p.x”; “u.p.x”; “p.u.x”; “p.x.u”; or “u.x.p”.

The idea is that when providing personal emails to people or institutions that request it, it is possible to add information in the address string so that it will identify the User sending the email. If for some reason, SPAM starts to arrive with that email account it is possible to deduct who is sharing personal information and reject those messages for that account. Of course is a matter of personal organization if for each email handed out, a User account is created for a real person or entity, or if virtual Users are created for temporary relationships that fall in certain categories.

There is an option to connect to a POP Server with an email application and the Server will provide all the EMail-Contents posted for the User in Mailboxes that are accessible for POP.

4.3. XML-Builder. Provides a way to plug-in any type of TCP/IP Server to the system. The Servers pass specific XSL to transform generic documents of the XML-Builder in to their own protocols. It offers a mechanism to merge documents.

In addition, by taking XML operations out of the Servers environments there is no conflict in the versions of Xerces, Xalan, JDOM and other tools used to perform those XSLT operations with the ones used by each Server. There is independence of the system and the Server, making it easier to change and Update Servers.

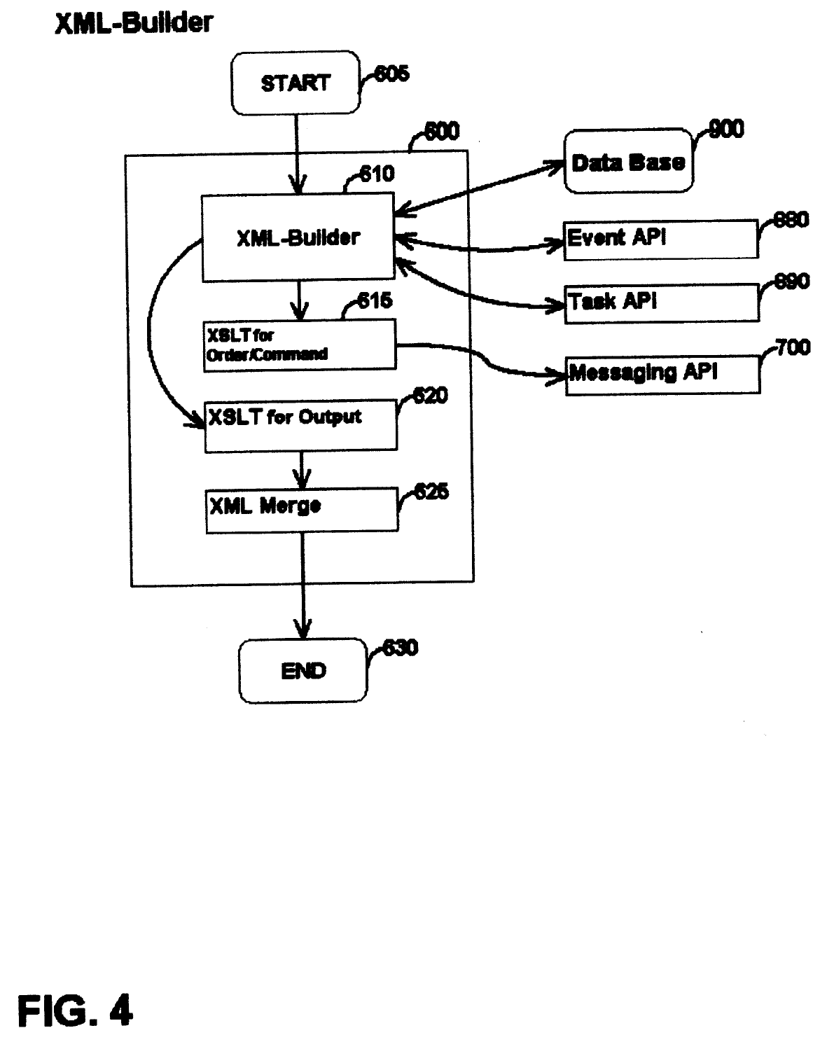

FIG. 4 Illustrates how a request coming from a Server is handled. It starts with a function call of the XML-Builder API 605. As said before there could be several requests from the Server for each connection from a Resource. Any request falls in three categories: Some function calls are just to generate an output document 615, a document to generate an Order 620, or both.

Functions of the XML-Builder API could access the Event API 880, Task API 890, the Messaging API 700 and the Databases 900.

There is an XML-Builder API function to call several functions at the same time, that includes commands using XPath to Transform, Delete, Create, Assign, and Transfer Nodes of each partial XML document outputs, and additional documents like the XML messages, and a seed of the XML final document. Those node operations could be done at the Server side instead of the XML-Builder side, but this approach reduces network traffic.

4.4. Database access is done through methods that retrieve the data in XML documents. There are Update, Delete, Create, and Query functions. The Query functions mostly call one function that translates a Query into an XML document.

4.5. XML-Processor. The XML-Processor executes Orders, manages Tasks, and EventListeners.

Orders and Commands are XML documents constrained to the DTD of FIG.

Orders are launched at run-time, but also can change and are transformed at run-time because they carry information to change and execute parts of themselves when they are processed by the XML-Processor. Orders can get a life of their own.

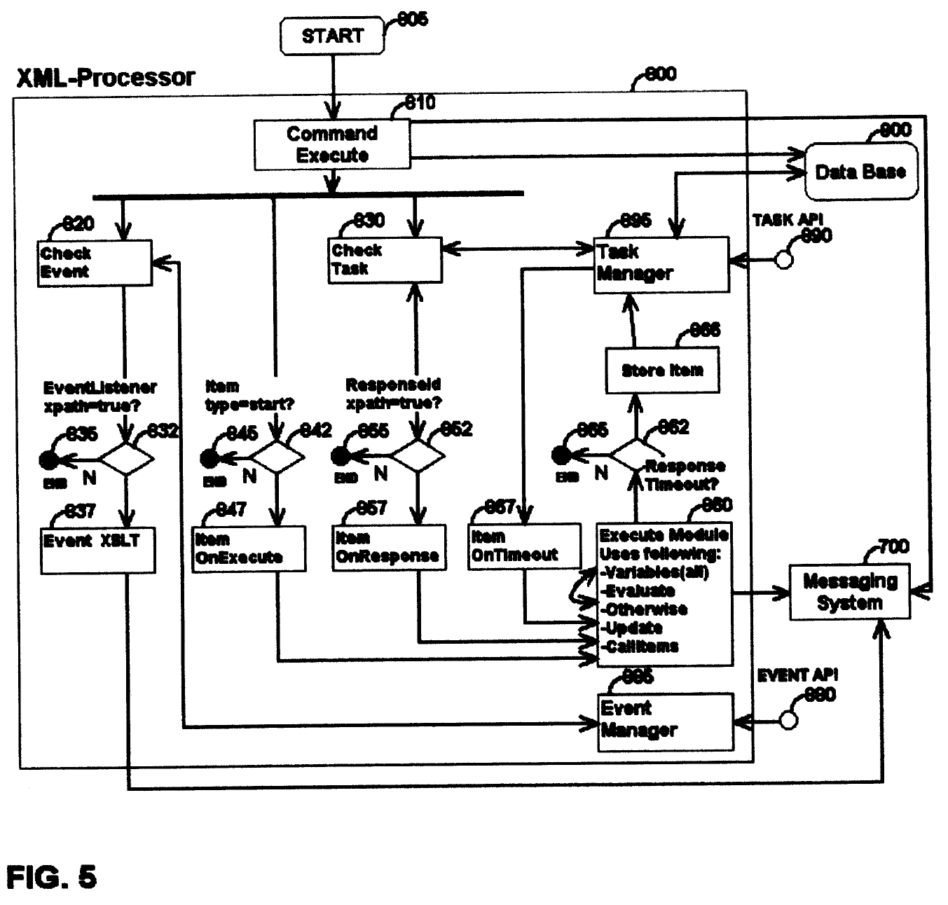

FIG. 5 Illustrates the Flow of documents through the XML-Processor. There are three ways for the XML-Processor to integrate to other applications: start 805 refers to the main thread of the XML-Processor that waits for documents coming from the Messaging System to its channel, the Task API 890, and the Event API 880 both accessed through RMI.

An Order is made out of Items that could have an OnExecute, an OnResponse or/and OnTimeout node. In each of those Nodes, there are variables (Variable), assignments (Update), conditional statements (Evaluate, Otherwise) and commands (CallItems). These Nodes are executed by the Execute Module 860.

Variables could be of the following types: integer, string and XPath (reference to nodes). Variables could be Global in an Item type global, Local to an Item, and from a Response document. The only condition for the Variables is not to have the same name.

At least one Item in the Order is of type “start”, or point of entry 842.

OnExecute 847: When the Order starts all OnExecute nodes of the Items of type start are executed. CallItems also executes the OnExecute node.

OnResponse 857: when a document passes through the system and matches each XPath in the ResponseId XPath list the OnResponse node is execute.

OnTimeout 867: If there is not a response after the time indicated in the ResponseTimeout node the OnTimeout, node of the Task (Item) is executed.

The Execute Module 860 deals with the Update, CallItems, and Evaluate/Otherwise Nodes according to the Order in the nodes. When the Item is executed, it is transformed with the XSL indicated in the SendTransform and sent on the channel indicated on SendTopic 700. The XML-Processor waits for a response only if there is a ResponseTimeout 862 and a ResponseId for the Item. The Item waiting for a response is called Task and a reference to the Item is included in the Task list 866. The entire Order is kept active in the system as long as there is one of its Items in the Task list.

CallItems carry a list of Item's names that should be executed. When the Item's name is included in the CallItems lists the OnExecute of that Item is executed.

An Update node carries information to perform operations of Variables.

Updates could be referring to mathematical operations (+,−,*,/,=) and XML node operation like replace, delete, add and copy. If the Node referenced in by the Variable does not exist, the XML-Processor creates the respective node. An Update could even create more Items in the Order or replace them and modify the Order itself.

Evaluate is a node that allows the comparison between Variables (greater than, less than or equal to): If it is true then the child nodes Update, CallItems and/or nested Evaluate/Otherwise get executed; If false, and the Evaluate node is accompanied by an Otherwise node, that Otherwise node is executed.

An Order could be structured so that it could handle very complex tasks integrating with different Interfaces that use the Messaging system and then COM, DDE, CORBA, RMI to communicate with other Applications.

There is a great advantage of orders over programming. Without any modifications of the software, just by editing commands the behavior of the system could be modified completely.

4.5.1. Event Manager 885. Events triggers could be any XML document going through the XML-Processor. The Event Manager has an RMI interface to subscribe and unsubscribe EventListeners 880.

The Event API to enroll and EventListener requires: (a) the SessionId; (b) an arbitrary Name to identify the EventListener; (c) an XPath list (a list of XPaths separated by;); and an XSL-Content reference or Content Id.

To remove the EventListener just SessionId and the Name are passed.

When all XPaths in the list are valid when applied to a document going through the XML-Processor, an Event 837 is triggered and an Order or Command will be produced with an XSLT transformation of the XML document that triggered it and said XSL-Content.

When the Session dies (expires) or is terminated all EventListeners for that Session are removed automatically.

4.5.2 Tasks Manager 895. Tasks are Items of an Order that were executed and indicated with the ResponseId and ResponseTimeout nodes that they require a response.

All Tasks have therefore a timeout. The Task manager keeps track of Tasks and signals when to execute OnTimeout nodes 867.

The Task API 890 provides a set of functions to list and remove Tasks from the Tasks list. Tasks are Items that were execute and with the ResponseId and ResponseTimeout nodes indicated that a response was require. The API is used to monitor the status of Tasks and in special cases to remove tasks manually.

5. Display Content.

Communication is achieved by displaying Content to Sessions.

Display-Option refers to a specific way, a specific working area (window) on the screen or/and a specific device to display Content. All Contents have a default Display-Option selected. With the User interface, Content-Display-Options-View, it is possible to select a different Display-Option from the default.

Most of the time all visual Contents can be displayed in an HTML together, sequentially in order of the Content to Content Relationship reference in a window called Main in specific coordinates of the screen. That option is called Display-Option-Main.

It is convenient to have different Display-Options because for example:A Session needs to complete a Questionnaire-Content, and meanwhile if there is a need to communicate with the Session, if a Content is displayed on the same window, it will erase what the User has entered in the questionnaire.

By creating a Display-Option-Questionnaire that works in the same way as the Display-Option-Main, but shows in a window called Questionnaire in other coordinates, it is possible to avoid this problem.

A Display-Option could add many different features. The PicturePlayer allows drawing objects and a pointer on an Image and sharing that with all the other Sessions in a Group, that Display-Option is called Display-Option-PicturePlayer. The Display-Option-Main would just display the picture.

It is simple to create a new Display-Option: it is required to create an XSL that transforms the Contents into an Order; create an entry Display-Option table to get the Display-Option Id; create an entry with the Display-Option Id for each Content-Type that the XSL can handle in the Content-Type to Display-Option table of the configuration Database; and if necessary create an entry in the fallback table of the configuration Database. Following are some embodiments of Display-Options:(a) Main, Questionnaire: In general, all visual Contents can be displayed in a Browser Window. Main and Questionnaire are related to specific Browser Windows, with a specific size and location in the screen. They are like working areas. The Display-Option-Questionnaire could be used to display Questionnaire-Contents and the Display-Option-Main could be used to display other Contents.

(b) Message: It is mostly used by the system to display status and error text messages in a Browser frame from the Main Application window. The main characteristic is that the window frame exists embedded in the main web page.

(c) DocumentViewer: is combination of windows, and scripts to synchronize the location in a long document for a Group of Sessions.

(d) Streamer: is a combination of windows, scripts and a video player Object that displays video. It allows synchronizing the location in the video for a Group of Sessions.

(e) PicturePlayer: indicates that the image should be displayed in the Applet called PicturePlayer.

The process of displaying a Content requires a production of an Order. The Order is an XML-document produced with the information stored in the Databases regarding the target Session and resources available; User and his/her preferred resources; the Content itself, Content Childs and their Content Formats; Group where they belong; System Configuration and a preferred Display-Option and extra parameters when the display action is requested.

In the production of the Order the server side resources are taken in consideration: Several servers could provide the same or similar services in a distributed environment and the selection of said server could be based on load balancing rules, geographical location of Users, or maintenance.

Each Session has a specific set of resources (Browser with Frames, Browser with no Frames, Applet, Client Application), and the respective Channels opened to communicate with those resources.

Different resources are able to display a different set of Display-Options.

Some Display-Options are closer in what they do to other options. When there is a communication with a Group, since different Sessions have different resources, frequently the preferred option to display a Content will not be possible for some Sessions. In the production of a display Order the XML-Builder tries to match resources for the Session with the selected Display-Option according to the Display-Option table, if unsuccessful will choose the next Display-Option in the fallback Table and repeat the cycle until successful.

For example in one embodiment of the system, if a Session resources doesn't include java, the system will know from the resource Display-Option table that the Display-Option-PicturePlayer won't work and the system will choose to display it in the Display-Option-Main according to a fall-back table.

The same for a text message when sent to a Java-Applet chat-application, if the Session's Browser does not support java the message is sent to an HTML-based chat application.

In the event there are no resources to display a Content, in any available formats, at least the system will display a text message informing the target Session that it was unsuccessful.

When a Content is displayed; the Content and all its Childs are displayed. The List of Contents Childs is modified according to Conditional-Contents. Those Contents are grouped in pages as indicated in the Content-to-Content relationships section.

6. Post Content.

Posting Content works in the same way displaying Content works. Posting refers to asynchronous communications so it requires a User as a target not a Session.

Some of the postings possible in the system are: Sending an email to User with a reference to a link to see the Content; Sending a MIME document with the Content output; Adding Content in the User to Content relationship to be shown in the User's message box; Adding Content in the User to Content relationship to be used to cache Content by the Client Application. An email with attachemts is a Content Message, Content-HTML with different types of Contents as Childs.

7. User Interface

7.1. Session-Monitor-View. A Group is required for the Session-Monitor-View. There is the option to select NO and ANY as a Group that respectively will select all the Sessions that do not belong to a Group and all the Sessions.

The View is a list of the Sessions as rows and a list of Services as columns.

Services are an abstraction of resources or Group of resources available for the Session. They make it easier to know what resources are available, what is their status, and to send simple commands to them.

The Columns indicating the services are customizable according to the usage of the system. One embodiment provides a view with the following columns:One Column is the transfer Column. When selecting transfer for a Session, a transfer Window is opened.

Another column indicates if there is an Applet connection or not. When pressed it could trigger different actions, currently it just rings/plays a sound in the station of the respective Session. Since commands to the Browser could be pushed to the Browser via the Applet, if there is an Applet connection it is possible to tell that the displaying of Content for the respective Session happens almost immediately.

A third column indicates if the Session is able to capture audio. It indicates status and triggers actions when selected in the following ways: (a) No recording resources available, no action is enabled; (b) Idle, recording is possible but is not recording, when pressed it starts recording; (c) Wants to talk or send/broadcast a message, when pressed starts recording and broadcast for that Session; (d) Recording/Broadcasting, when pressed stops the recording for that Session.

This column is particularly useful in a classroom setting to enable total control for the teacher. Students are forced to ask for permission to talk (like raise hand) and the teacher signaling when it is ok to talk, or the teacher could also put a student on the spot with a question.

It works in conjunction with the Applet UI. Since capturing audio requires the Client Application to be running, it is possible to deduct that if this column is active that other resources could be available for that Session, and that the Caching system is working.

Video could be added as a fourth column to indicate if there are ways to capture video and it would work like the third column.

7.2. Session-Transfer-View. The view is produced with the Session to be transferred and the Session transferring. List on the left side selectable objects that represent each of the Groups the Session belongs to or is on hold and List on the right side selectable objects that represent all the available Groups for the transferring Session to transfer Sessions to. On the left and right, it has an extra selectable object each, that help to add the Session to groups or remove them from groups without transferring.

The view has other Objects used to remove the Session from the site, and to ban Session from ever connecting again to the system for example.

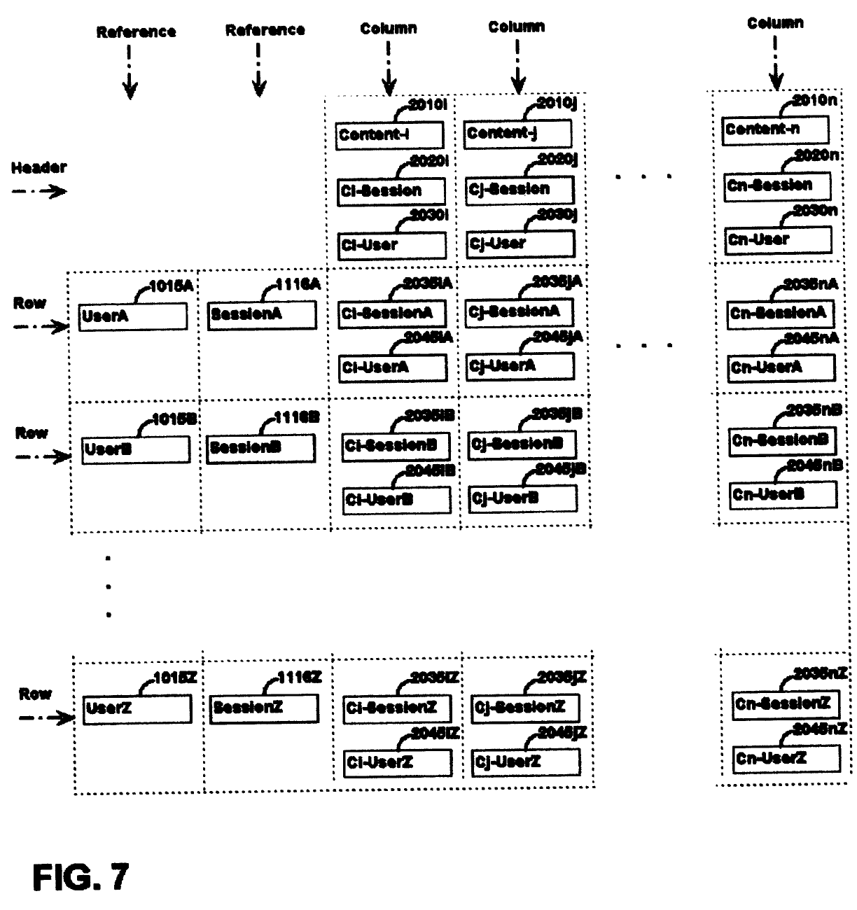

7.3. Content-Monitor-View. FIG. 7 Illustrates the View of Sessions/Users vs. a List of Contents.

The list of Contents is normally a Content and its Childs, but could be a selection of any Contents.

The View of Sessions vs. List of Contents and the Users vs. List of Contents look are very similar, but the Objects mean something and trigger actions in a different way.

First, the view will be explained according to a list of Sessions and then the difference when it is about a list of Users.

FIG. 7 shows three distinct sections: Column/Header, Row/Reference and Row/Column.

Column/Header section has a plurality of sub-sections related to each Content in the list, Content-i to Content-n. In each sub-section there are a plurality of Content-n 2010n, Cn-Session 2020n and Cn-User 2030n objects that respectively with their embodiment provide information or trigger actions regarding each Content-n, Content-n and all the Sessions, and Content-n and all the Users related to the respective Session in the list from A to Z.

In one particular embodiment each sub-section has one Content-n object that shows an image characteristic of the Content-Type and triggers and action to edit Content-n, its Childs and Parents; one Cn-Session object used to trigger the Content-Display-Option-View to display the Content-n to all Sessions; one Cn-User object used to trigger the Content-Post-Option-View of Content-n and all Users related to the respective Sessions. Cn-Session objects have a special behavior if none of the Sessions is active, as opposed to at least one Session is active. Cn-User objects have a special behavior if none of the Sessions is logged in as opposed to at least one Session is logged in.

Row/Reference section has a plurality of sub-sections related to each Session from A to Z. In each sub-section, there is a plurality of SessionZ 1116Z and UserZ 1015Z objects that provide information and trigger actions respectively for the SessionZ and UserZ.

A Session does not have a relationship to a User if it has not logged in; in that case, the objects related to the User are disabled, indicate that there is no User or trigger dialogs informing that the Session does not belong to a User.

In one embodiment of the View, there are two UserZ objects: one just shows the Color that identifies the User, and inside it, an object providing the Picture of the User that identifies him/her. If there is no User the color is according to the background chosen for the view, and the picture clearly indicates that there is no User related to the Session. The Picture-object triggers an action to edit the User.

There are 3 SessionZ objects: (a) one to shows the color assigned to the Session; (b) an other the picture assigned to the Session, this Picture-object triggers the display of a window to edit the Session where there is information about the resources used by the Session; (c) and there is another SessionZ object used to display a list of all the Contents (pages or part of pages) visited by the Session.

Column/Row section has a plurality of sub-sections in a matrix related to Contents from i to n and Sessions from A to Z where there are a plurality of Cn-SessionZ 2035nZ and Cn-UserZ 2045nZ objects. Where each Cn-SessionZ and Cn-User-Z objects provide information or trigger actions respectively to the Content-n in relation to Session-Z and Content-n in relation to User-Z. Again, if there is no User related to the Session then those objects are not active or indicate that there is no User for the Session.

In one embodiment of the view, there are several Cn-SessionZ objects: (a) one object has an image to indicate correct 100%, wrong 0%, somewhere in between 0% and 100%, responded but not evaluated for Question-Contents, and images used with the other Content-Types also to indicate if a display of Content was requested for Session, if the Session retrieved the Content or if there has not been a relationship between the Session and the Content yet. These objects trigger the opening of a Content-Evaluate-View.

(b) another object indicates with its color for a Question-Contents if it has been manually evaluated or not.

(c) and another object to trigger a Content-Display-Option-View for Content-n to SessionZ.

There are several Cn-UserZ objects also:(a) one object used to trigger a Content-Post-Option-View for Content-n to UserZ.

(b) one object that with its colors shows: a cache command has been posted, currently is caching Content, Content is cached, or error in caching.

(c) one object that with is colors shows if Content has been posted, posted and emailed, has been read or if there was an error sending email.

When it is about a list of Users instead of a list of Sessions the differences are:There could be a plurality of SessionZ 1116Z objects related to all Session logged in as UserZ.

Cn-Session 2020n objects are in relationship to the last Session opened for the User.

The Cn-SessionZ 2035nZ objects are in relationship to the last Session opened for the User and to other criteria like: (a) the last Session that had a relationship to the Content; (b) the last Session created in a specific period of time; (c) the Session with the best score for Question-Contents; (d) the Session with the worst score for Question-Contents; (e) a combination of the above.

In one embodiment, Sessions are selected just based on (a).

7.4. Content-Post-Options-View. The View is built with one Content and a list of Users and the options for non-Synchronous message. In one embodiment of the view the post options are: (a) Message-Box; (b) EMail with a link to see the Content using the web site; (c) EMail as a MIME message; (d) Cache.

There is an option to add a message to attach to the posting, and a menu to embed the Content if it is an EMail reference, and an option to execute or cancel the post.

7.5. Content-Display-Options-View. The View is built with one Content and a list of Sessions. Each Content-Type has a list of possible Display-Options according to the configurations table.

The View shows the Content, all it”s Childs, and a combo-box to select Display-Option and an option to execute display or cancel.

It could show also a distinction of the different pages that the displaying will entail and a way to select all or a specific page to display.

7.6. Content-Evaluate-View. It is built with a Session and a Content. If the Session is related to a User it will show all other Sessions for the User that have a relationship to that Content recorded in the Database.

In one embodiment, the Session used to build the View will always show in a distinct way, the background has a different color. If there has not been a relationship with the Content before and there is an update, the relationship between Content and Session is created.

The view is according to the Content-Type and if it is a Question-Content according to the type of question.

For a Question-Content a manual score selection box is available for each Session. If the question can be automatically evaluated that score is shown. Scores are in a 0 to 100 range. The manual score overrides the automatic score.

An entry for a text message is provided to enter comments about the response, or the relationship.

In assignments type of questions there is the possibility to display a Content, if a Content was used for the response, and/or to display a file used to provide the response (not necessarily a Content). There are also options to set a relationship to a Content and to a File as if responding to the assignment.

7.7. Reports. Reports are defined by SQL queries and XSL-Contents to transform those queries in a displayable view.

8. Other Applications Integrated to the System

8.1 Appos. In one embodiment, an Appointment Management Application (Appos) is integrated in to the system.

Appos establishes a schedule for a User providing appointments according to different types of Appointments that have specific time slots over a period.

Different Users who ask for an appointment have different privileges to choose and set their appointments.

The application offers an API that provides an XML document with the Schedule for a set of appointment types where appointments and slots are included. The function requires the list of Users providing the appointment, the User asking for the appointment, the type of appointment, a date range and a time range.

The XML-Builder accesses that API and makes it available to the Servers.

XML-Contents could reference JSPs or CGIs from the HTML or WML Servers, add the appropriate parameters, and indicate the XSL-Contents to use to transform the generic XML documents produced by said API.

1. A method and a system for integrating and coordinating resources using the internet or intranets for synchronous and non synchronous communications by displaying Content;
wherein said resources are any devices, applications, programs, ActiveX, or embedded objects that could receive directly or indirectly commands to perform actions related to a Content; wherein said Content is any data or reference to data that could be used by a resource; wherein said data could be static or produced live; wherein displaying is the process of building at run time and sending for each party involved in the communication a personalized Order that when executed, Commands are sent directly or indirectly to the resources available for the respective party that will closest match a desired action; wherein a Command execution could entail setting properties, calling methods or functions, or triggering events in a resource; wherein instantiation of a resource with the respective parameters or arguments is considered also sending a Command; wherein coordinating refers to the fact that more than one of said resources could be involved in the displaying of said Contents, and that said resources are not necessarily the same in all the parties involved in the communication and is expressed in the complexity and uniqueness of each of said Orders;

2. A method and a system based on claim 1 that allows using just four basic elements in the User Interface: Contents, Sessions, Users and Groups, and different kinds of relationships among those four elements to configure and manage the whole system;
wherein mentioned parties involved in the communication are either Users or Sessions; wherein mentioned data is provided by Servers; wherein Session-Id is a key used at the server side to group all the resources connected directly or indirectly to any Server from the same computer; it is a function of any server integrated to the system to identify the Session in a connection; wherein Sessions are opened every time someone connects for the first time and closed for good after a timeout without any connection to any server integrated to the system; wherein User is a known individual or a Session that has established a relationship to a User; when a Session loges in, the Session belongs to the User; wherein virtual User accounts could be created for devices that do not have a relationship to real People; wherein opened Sessions are used for synchronous communications; wherein Users are used for non-synchronous communications; wherein Groups are groups of either Users or Sessions; wherein Contents in relationship to Sessions, Users and Groups modify their respective properties; wherein Contents in relationship to other Contents increase their complexity; wherein mentioned personalized Orders are documents produced according to the Sessions, Users, Groups, and Contents directly or indirectly involved in the communication and the system configuration;
wherein said system configuration refers to a Table with information about what resources can handle what Display-Options, and a Table of fallback that indicates in case there is no resource that can handle selected Display-Option, what Display-Option should be used next because probably is also next in matching the intended action; wherein said Display-Option refers to a particular way the handling of the data should be done; wherein said system configuration does not need to be changed, and therefore is not needed in said User Interface of the system. wherein each of said Servers updates the Session to Content relationship data, so the history of a Session in relationship to each Content, including responses submitted for Question-Contents can be tracked;

3. A method and a system based on claim 1, where a Browser becomes a bi-directional communication resource independent from the mechanism used to pull or push commands to said Browser;
wherein commands are embedded in the HTML responses for Browser's requests; wherein the Commands are according to said Browser's capabilities like javascript and java enabled; wherein several options can be used to force said Browser's request without a User's input, some of said options are: (a) The use of HTML-Tag like <META HTTP-EQUIV=“Refresh”> to pull said commands; (b) The use of an Applet that maintains a connection to the system all the time pushing commands in the following way: when the Display Order is built for a Session that indicates that there is an Applet connection, it includes said command to said Browser, and an additional command to said Applet to execute showDocument( ) and force said Browser to request a page and therefore read the command; (c) The use of an application that maintains a connection to the system pushing commands to said Browser in the same way as in said Applet but by executing a DDE pop-up instead of a showDocument( ); wherein all commands sent to the Browser could be executed by just one retrieval of an HTML-page from said Browser; wherein said Commands to the Browser have a Name, Body and Header and when said Commands are merged in the HTML-response only one Body, and all the Headers are added for all Commands with the same Name.

4. A method and a system to transform Orders at run-time where they could get a life of their own;
wherein said Orders are XML documents that are executed by an XML-Processor; wherein said Orders are made out of nodes called Item; wherein said Items have integer, string and XPath (reference to nodes) Variables, and they could be global to the whole Order, local to the Item, and from a Response document passing through the system; wherein said Items have a unique name attribute; wherein said Items have OnExecute, OnResponse, and OnTimeout nodes that are executable; wherein the execution of said executable Nodes deals with the Update, CallItems, and Evaluate/Otherwise Nodes; wherein CallItems carry a list of the names of the Items that should be executed; wherein Evaluate/Otherwise allows the comparison between Variables (greater than, less than or equal to), if true then the Childs of the Evaluate, if false the Childs of the Otherwise node are executed recursively; wherein Update node carry information to perform operations of Variables, mathematical (+,−,*,/,=), string (+,=) and node operations like replace, delete, add and copy; wherein node operations could modify the Order itself; wherein OnExecute is executed when the Order is received if its parent Item is of type start, or if its parent Item's name is in the CallItems list; wherein at execution the Item is transformed with the XSL indicated in the SendTransform into a Command or another Order that is sent on the channel indicated on SendTopic nodes; wherein the XML-Processor waits for a response only if there is a ResponseTimeout and a ResponseId for the executed Item; wherein an Item waiting for a response becomes a Task; wherein OnResponse is executed when a document passing through the system matches the ResponseId's XPath list of the Task; wherein OnTimeout is executed, if there is not a response after time indicated in ResponseTimeout is elapsed.

5. A method and a system based on claim 4, to handle Events using Content; wherein said Events are any documents, either Orders or Commands processed by the XML-Processor;
comprising the steps:(a) enrolling the EventListeners by using the XML-Processor interface and passing an XML-header, an XPath list, a reference to an XSL-Content, and a reference id; (b) transforming said document together with said XML-header with said XSL-Content into an Order, when all said XPath in said list return valid when applied to a document passing through the system; (c) said Order including Commands to the required resources and Server side components to handle the Event; wherein said method and system allows to have in general any Application monitoring the system comprising the steps of: (a) creating all XSL-Contents needed to transform the Events to be monitored; (b) said application creating a channel to communicate and creating a thread to process the messages received in said channel; (c) the application enrolling the EventListeners with the respective XSL-Content reference, XML-Header, XPath list and reference id; (d) the application handling the commands received in said opened channel product of the Orders produced when said Events are detected; wherein said methods and systems allow in particular to have an OnEvent handler for HTML pages, which means that with a Browser that is JavaScript and frames enabled, an HTML page could be updated according to Events without the need of reloading the whole page; Said method comprising the steps of: (a) creating all XSL-Contents needed to transform the Events to be monitored; (b) every time said page is requested, enrolling all the required EventListeners with the respective XSL-Content reference, XML-header, XPath list and reference id;(c) said XSL-Content producing Orders with commands for the Browser that include JavaScript functions that when executed in the frame that receives said commands change said page loaded in another frame;(d) every time said page is unloaded, removing the EventListeners with the respective reference id.

6. A method and a system based on claim 1 and 4 for caching Content;
wherein with a Client Application following the steps of: (a) said Client Application connects to a server integrated to the system and identifies the user it belongs to; (b) said Application using said connection to check periodically in the list of Contents posted for said User and in the list of Contents to be synchronized in the Groups where said User belongs to for Contents to be downloaded; (c) said Client Application starting the downloading of said Contents if not found or out of synch in the local machine; (d) mentioned XML-Builder producing a display Order for said User that when said User's Client Application is connected and the Content is cacheable will indicate to the resource to retrieve the data from said User's local Client Application and not a remote server; (e) wherein said Client Application being able of retrieving the Content's data from the server at the same time the data is sent to the resource; (f) wherein the Client Application could enroll EventListeners mentioned in claim 5, so that it starts caching Contents at the moment they are posted and be ready for when they are requested.

7. A method and system based on claim 1 and 4 to automate handling of Sessions connected to the system according to the display of Contents in specific rolls in the different relationships to Groups, Sessions, Users and other Contents;
wherein Events could trigger the displaying of Content in said rolls;
wherein by using Conditional-Content in said rolls it is possible to personalize and add intelligence to the interaction between the system and the session; wherein said Conditional-Content carry information regarding an SQL statement, the database to apply said statement and an XSL-Content reference to transform the SQL result; wherein said SQL result, an XML document, is transformed with said XSL producing a document that contains a list of Contents; wherein said list of Contents replaces said Conditional-Content with relevant information at run-time; wherein the display of an XSL-Content could entail the creation of Orders; wherein the interaction could refer, but is not limited to:(a) transferring Sessions; (b) notifying Users that someone wants to communicate; (c) notifying Sessions that they are on hold, have been accepted to a Group, please leave a message, sorry I am busy, please call later and many others;(d) sending questionnaires; (e) displaying other contents according to responses to questionnaires; (f) displaying content according to information stored in the database; (g) processing payments.

8. A method of organizing objects in three distinct sections corresponding to the relationships between a list of Sessions and a list of Contents or a list of Users and said list of Contents (refer to FIG. 7);
wherein said sections are Header/Column, Row/Reference, and Row/Column; wherein said objects according to their embodiment and alignment provide information and can be used to trigger actions; wherein said Header/Column section further comprising of a plurality of Header/Column-n sub-sections; wherein the embodiment of the objects in said sub-section provide information related to Content-n and can be used to trigger actions related to Content-n, Content-n involving all the Sessions and Content-n involving all the Users related to said Sessions; wherein said Row/Reference section further comprises a plurality of Row-m/Reference sub-sections; wherein the embodiment of objects in said sub-section provide information related to Session-m and can be used to trigger actions related to Session-m and if Session-m is logged in provide information related to the respective User and trigger actions regarding said User; wherein said Row/Column section further comprising of a plurality of Row-m/Content-n sub-sections; wherein the embodiment of the objects in said sub-section provide information related to the relationship of Session-m with Content-n and can be used to trigger actions related to that specific relationship and if Session is logged in provide information related to the relationship of User-m with Content-n and can be used to trigger actions related to their respective relationship; wherein said Row-m/Content-n sub-section is aligned to the respective Row-m/Reference and Header/Content-n sub-sections; wherein in the case of Users instead of Sessions Objectives could be placed in the three distinct sections in relationship to the Users; wherein said sections are Header/Column, Row/Reference, and Row/Column; wherein said objects according to their embodiment and alignment provide information and can be used to trigger actions; wherein said Header/Column section further comprising of a plurality of Header/Column-n sub-sections wherein the embodiment of the objects in said sub-section provide information related to Content-n and can be used to trigger actions related to Content-n, Content-n involving all the Users and Content-n involving all the Sessions that are open for respective Users; wherein said Row/Reference section further comprising of a plurality of Row-m/Reference sub-sections; wherein the embodiments of objects in said sub-section provide information related to User-m and a plurality of Sessions related to User-m and can be used to trigger actions related to said User-m and said Sessions; wherein said Row/Column section further comprising of a plurality of Row-m/Content-n sub-sections; wherein the embodiment of the objects in said sub-section provide information related to the relationships of User-m with Content-n and the relationships of a plurality of Sessions related to User-m with Content-n; wherein said objects in the Row-m/Content-n sub-section can be also used to trigger actions related to their respective relationship; wherein said Row-m/Content-n sub-sections are aligned to the respective Row-m/Reference and Header/Content-n sub-sections.

9. A method and a system based on claim 8 to identify and get information about Sessions, Users connected at the moment and/or in the past;
wherein the method of organizing Objects could be applied to an active or closed Session, or a User and any to all the Contents it has had a relationship with; wherein said plurality of Row/Content-n sub-sections link to information related to the relationships of said Session and/or User with each Content; wherein said plurality of Row/Reference sub-sections link to all sorts of information related to said Session and/or User;

10. A method and a system to calculate final Grades using Content based on the value-weight that can be entered for each Content-Child of a Content;
wherein the grade for a specific Question-Content goes from 0 to 100, and can be graded manually or automatically; wherein the final grade is obtained with the result of a recursive evaluate function that has as parameters the maximum score, the Content and the Session for whom the final grade is calculated; said function first adds all the value-weights of the Childs of the first generation (direct Childs) in to a total-value-weight, then for each of said Child Contents checks if it has more Childs; if said Child Content does have more Childs the result of a recursive call to the evaluate function is added to the final grade; said recursive call gets the respective value-weight divided by said total-value-weight and multiply by maximum score as the new maximum score, said Content Child and said Session; if said Content Child does not have more Childs the value-weight divided total-value-weight and multiplied by the score for respective Content and Session is added to the final grade; wherein instead of Session there are Users; wherein the grade is calculated base on Sessions related to said Users and a selection criteria for said Sessions in relationship to respective Content based on but not limited to: the Session with the last relationship to the respective Content; the Session with the relationship to respective Content with the best score; the Session with a relationship the respective Content where the response was entered in a specific date range; the Session chosen based on a combination of previous criteria; an average of all Sessions with a relationship to respective Content.

11. A method and a system to set rules for Users to post any type of messages using Content;
wherein a User can receive messages according to the following address structures: x.u.p@server; x.u@server; or x@server; wherein x, u, p are strings of any length of any characters or numbers not including special characters defined in the configuration file; wherein x refers to the User-account field for the record of the User receiving the message; wherein u refers to a unique Content in a specific roll for the User sending the message; and wherein p refers to an additional Content in the same roll for the User sending the message; wherein the identity of the receiver is defined by the unique identifier x, and the identity of the sender is defined by the unique “u” or “u” and “p” strings; wherein in the case of emails and SMTP servers the address structure can be taken literally; wherein in case of other servers the address structure may not be taken literally: in the case of a voice mail, for example, “x” refers to a phone number/extension, “u” and “p” are gathered through DTMF, by pressing additional keys after respective prompts and the server is the voicemail system itself; wherein the server receiving the message gathers additional information from the connection, or the message itself; wherein the identity of the sender could be also established with mentioned additional information, like the senders email address or caller id; wherein a message could be classified in three different ways: as coming from a know User, a not known User or an Invalid identification; wherein Content-Mailboxes are set to receive messages according to the identity of the sender and receiver, the mentioned three classifications, and the mentioned additional information gathered by the serves; said Content-Mailboxes hold information on how to handle the message particularly in regards to accepting, or rejecting the message and penalizing the connection by delaying the final termination; wherein posting messages to said Content-Mailboxes could trigger Events that could be used to notify target User live, and in the case of bidirectional communications he/she could display specific Content to “answer”/establish a synchronous communication; wherein Content-Mailbox in specific rolls for a User establish the permissions to see/retrieve or not the message; wherein placing a message in a Content-Mailbox that is not in the roll Content to User that indicates it is accessible to be read, is a way of filtering out messages for a User.

12. A method and a system to manage appointments using the Internet based on Content, Users and Groups;
wherein the person asking for an appointment and the person giving an appointment have User accounts created in the system; wherein Users providing appointments build schedules for different types of appointments; wherein said schedules for appointments are made based on Users giving appointments, the type of appointment, date range, time range; wherein the view of said schedule is built using said XML-Content, XSL-Content to transform the output and the User requesting the appointment and related Contents; wherein different types of servers could use same XML-Content and respective XSL-Content to display same schedule in their respective formats (HTML or WML for example); wherein a relationship between a Group(s) and an XML-Content that represents said schedules gives the Users belonging to mentioned Group(s) access to said schedules;
